(19) United States
(12) Patent Application Publication
(10) Pub. No.: US 2019/0246867 A1
(43) Pub. Date: Aug. 15, 2019

(54) Double-Handle Apparatus

(71) Applicant: Peter J. Ziamandanis, Loudonville, NY (US)

(72) Inventor: Peter J. Ziamandanis, Loudonville, NY (US)

(21) Appl. No.: 16/244,766

(22) Filed: Jan. 10, 2019

Related U.S. Application Data
(63) Continuation-in-part of application No. 16/188,710, filed on Nov. 13, 2018.
Application No. 16/188,710 is a continuation-in-part of application No. 16/042,291, filed on Jul. 23, 2018.
(60) Provisional application No. 62/630,933, filed on Feb. 15, 2018.

(51) Int. Cl. A47L 13/42; A01B 1/02; E01H 5/02; A47L 13/20; A01B 1/22; B25G 3/36; A01D 7/00; B25G 1/00; A01B 1/06

(52) U.S. Cl. CPC A47L 13/42; A01B 1/026; E01H 5/02; A47L 13/20; A01B 1/06; B25G 3/36; A01D 7/00; B25G 1/00; A01B 1/227

(57) ABSTRACT

A double-handle apparatus includes a cleaning apparatus, a primary support shaft, a secondary support shaft, and a handle. The primary support shaft, which functions similar to traditional handle shaft, includes a shaft body and a three-way connector section. A first shaft end of the shaft body is concentrically mounted within a mounting body of the cleaning apparatus. A second shaft end of the shaft body is concentrically integrated to a second connector section of the three-way connector, wherein the shaft body can be a straight or curved singular body, a straight telescopic body, or a straight modular body. The handle is adjacently connected to a first connector section of the three-way connector. The secondary support shaft is concentrically integrated to a third connector section of the three-way connector.

The current application is a continuation-in-part (CIP) application of a U.S. non-provisional application Ser. No. 16/188,710 filed on Nov. 13, 2018. The U.S. non-provisional application Ser. No. 16/188,710 claims a priority to U.S. non-provisional application Ser. No. 16/042,291 filed on Jul. 23, 2018. The U.S. non-provisional application Ser. No. 16/042,291 claims a priority to a U.S. provisional application Ser. No. 62/630,933 filed on Feb. 15, 2018.

### FIELD OF THE INVENTION

The present invention relates generally to a handle of a cleaning apparatus, garden tools, or any household tools that normally require a handle. More specifically, the present invention is a double-handle apparatus that enables a user to utilize cleaning apparatus, garden tools, or any other household tools without having to bend over to apply pressure against the ground surface or lift material being picked up by the tool.

### BACKGROUND OF THE INVENTION

A mop, an exemplary cleaning apparatus, is a mass or bundle of coarse strings or yarn, etc., or a piece of cloth, sponge, or other absorbent material that is attached to a pole or stick. It is used to soak up liquid, for cleaning floors and other surfaces, to mop up dust, or for other cleaning purposes. Even though there have been many different upgrades and changes done to the mop head, the handle has been consistent throughout all of those changes as the handle is shaped into a circular and elongated body. Standard mops can cause injuries due to awkward usage as the standard mops generally just have one handle that is connected to support the mop head. The user is meant to grasp the handle with both hands to properly use the standard mops. This requires the user to bend over, which is not conducive to protecting the user's back. A standard shovel, an exemplary garden tool, is a scoop that is connected to a circular and elongated handle. Standard shovels can cause injuries due to awkward usage. Shovels generally just have one handle and one support shaft connected to the head. The user is meant to grasp the handle with one hand and grasp the support shaft with the other hand. The design of almost all shovels requires the operator to use the shovel while bending over, which is not conducive to protecting the user's back. Resultantly, there is a need for an updated handle that is easy to use and maintain, while simultaneously reducing the need to bend over and the related stress to the user's back. What is further needed is a device that enables the user to apply downward cleaning pressure to the mop with both hands while standing in an upright position.

It is therefore an object of the present invention to provide a double-handle apparatus that includes two handles. The first handle is positioned similar to the existing handles of the cleaning apparatus, garden tools, or any other household tools. The second handle is an elongated handle that extends from the first handle and forms an acute angle with respect to the mop head or scoop. The second handle enables the user to grasp the mop from multiple gripping positions with one hand while the other hand is utilized to grasp the first handle. Resultantly, the user is able to utilize the present invention without bending over at the waist or spine during usage. Such motion prevents the user from worrying about damage to the user's back or body during use, while further allowing optimal leverage to apply pressure to ground surface or lifting material from the ground.

### BRIEF DESCRIPTION OF THE DRAWINGS

FIG. 1 is a perspective view of the present invention.

FIG. 2 is a side view of the present invention.

FIG. 3 is a side view of the present invention, showing the acute angle.

FIG. 4 is an exploded perspective view of the present invention.

FIG. 5 is an exploded side view of the present invention, wherein the shaft body of the present invention is a straight singular body.

FIG. 6 is an exploded side view of the present invention, wherein the shaft body of the present invention is a curved singular body.

FIG. 7 is a perspective view of the present invention, wherein the shaft body of the present invention is a straight telescopic body.

FIG. 8 is an exploded side view of the present invention, showing the proximal, intermediate, and distal telescopic sections of the straight telescopic body.

FIG. 9 is a perspective view of the present invention, wherein the shaft body of the present invention is a straight modular body.

FIG. 10 is an exploded side view of the present invention, showing the proximal and distal modular sections of the straight modular body.

FIG. 11 is a perspective view of the present invention, wherein the shaft body of the present invention is a straight modular body.

FIG. 12 is an exploded side view of the present invention, showing the proximal, intermediate, and distal modular sections of the modular telescopic body.

FIG. 13 is a perspective view of the present invention, wherein the head is a sponge mop.

FIG. 14 is a perspective view of the present invention, wherein the head is a dust mop.

FIG. 15 is a perspective view of the present invention, wherein the head is a wet mop.

### DETAIL DESCRIPTIONS OF THE INVENTION

All illustrations of the drawings are for the purpose of describing selected versions of the present invention and are not intended to limit the scope of the present invention.

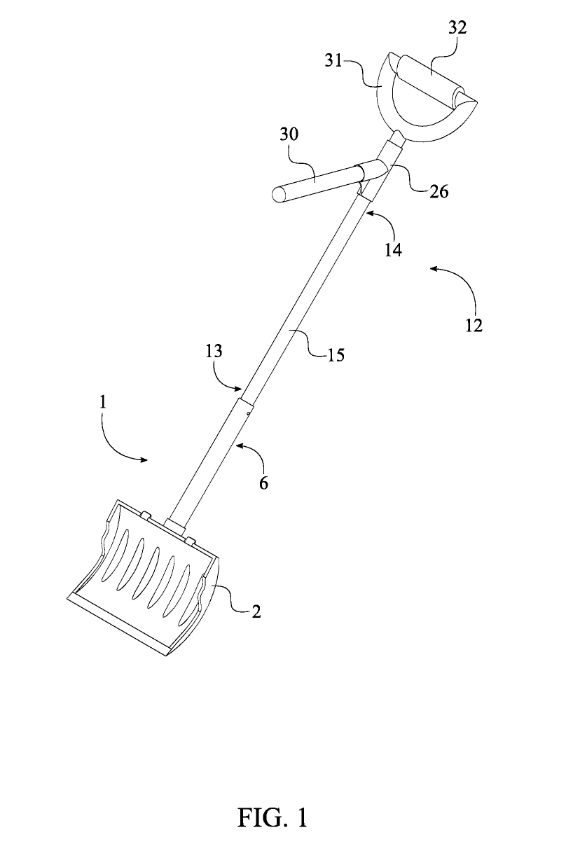

The present invention is a double-handle apparatus that enables the user to dry floors, remove contaminated liquid, clean floors, and remove dust that are accumulated on the ground. The components and their configuration of the present invention enable the user to accomplish above mentioned tasks without having to bend over at the waist or body during usage. The present invention comprises a cleaning apparatus 1, a primary support shaft 12, a secondary support shaft 30, and a handle 31 as shown in FIG. 1. The primary support shaft 12 and the secondary support shaft 30 enable the user to keep a straight back during usage of the present invention. In reference to the general configuration of the present invention as shown in FIG. 1-4, the primary support shaft 12 comprises a shaft body 15 and a three-way connector 26 section thus further defining the present invention. A first shaft end 13 of the shaft body 15 is concentrically mounted within a mounting body 6 of the cleaning apparatus 1, completing one end of the present invention. A second shaft end 14 of the shaft body 15 is concentrically integrated to a second connector section 28 of the three-way connector 26, which functions as the connecting hub for the secondary support shaft 30 and the handle 31. More specifically, the handle 31 is adjacently connected to a first connector section 27 of the three-way connector 26 while the secondary support shaft 30 is concentrically integrated to a third connector section 29 of the three-way connector 26.

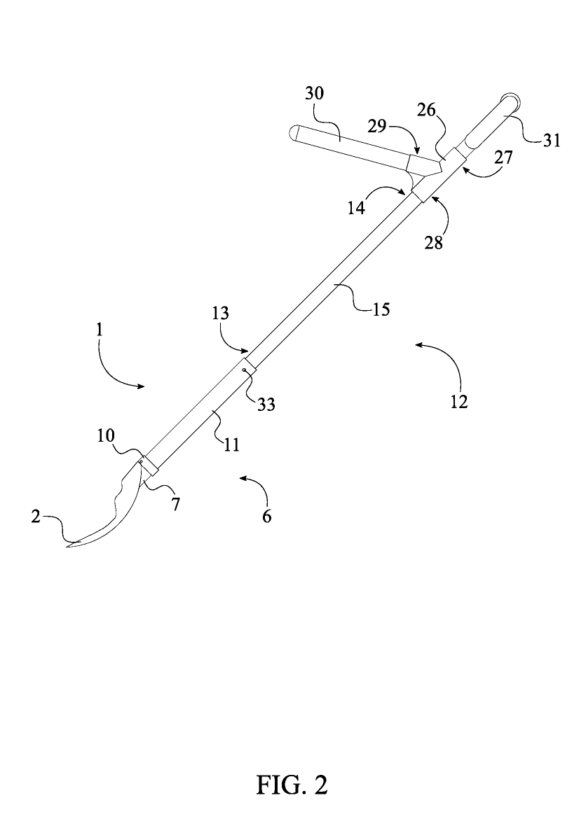

The primary support shaft 12 functions as the base 7 member within the present invention and allows the cleaning apparatus 1 and the three-way connector 26 to be mounted from each end. Furthermore, the primary support shaft 12 stabilizes the secondary support shaft 30 and eliminates any elastic deformation that can occur due the added weight of the cleaning pressure. The secondary support shaft 30 allows the user to grasp the present invention during usage so that the user can maintain a straight back. In reference to FIG. 1-2, the primary support shaft 12 and the secondary support shaft 30 generally shaped into elongated tubular bodies to reduce the overall weight of the present invention and to adopt for different embodiment of the present invention.

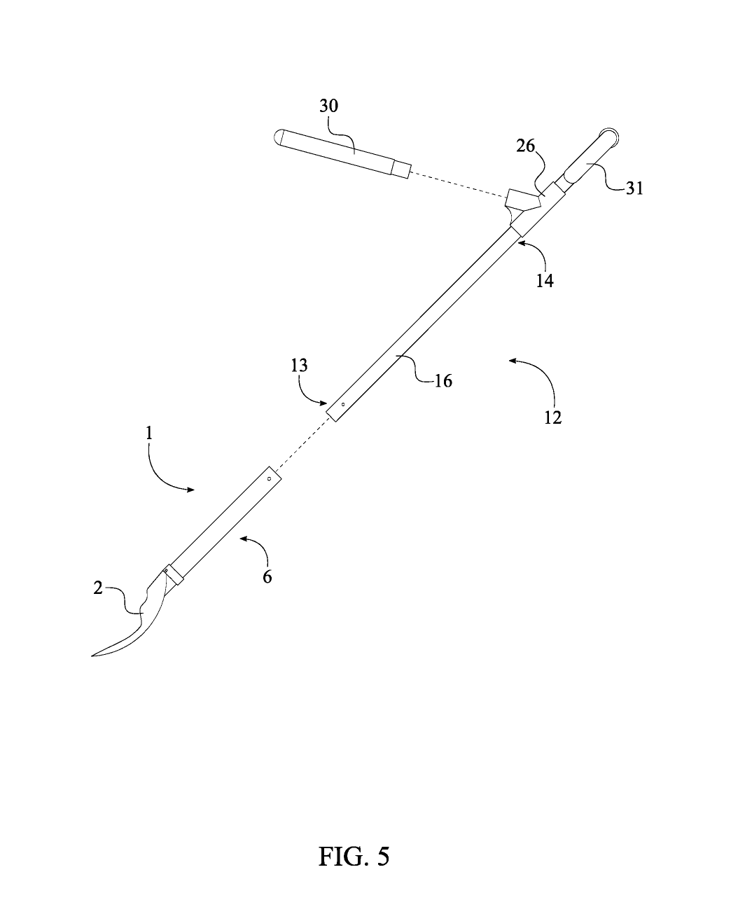

In reference to a first embodiment of the present invention, the primary support shaft 12 can be a straight singular body 16 from the first shaft end 13 to the second shaft end 14 as shown in FIG. 5. When the overall length of the present invention is fully determined, the straight singular body 16 for the primary shaft can be utilized within the present invention to minimize production cost and to maintain a simplified production process.

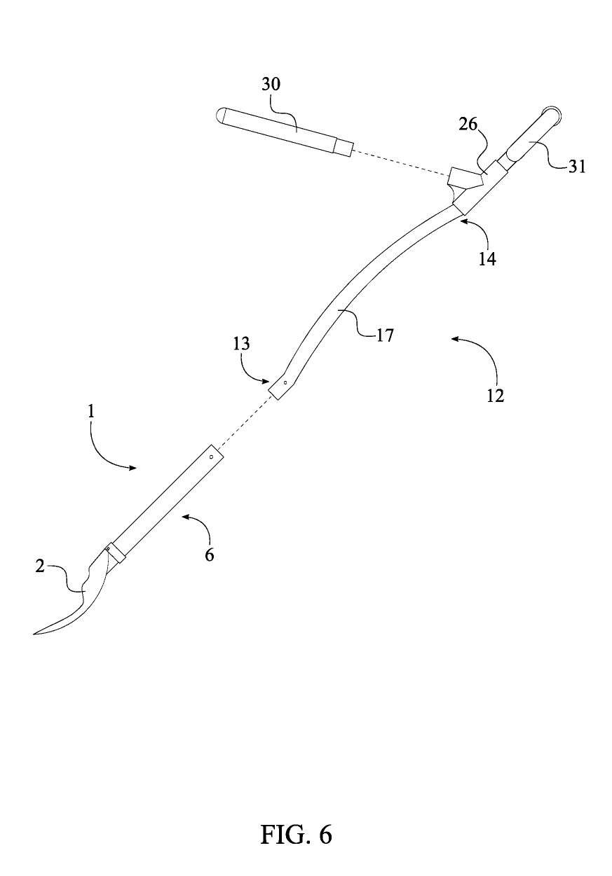

In reference to a second embodiment of the present invention, the primary support shaft 12 can be a curved singular body 17 from the first shaft end 13 to the second shaft end 14 as shown in FIG. 6. Furthermore, a convex side of the curved singular body 17 is oriented towards the secondary support shaft 30. The curved singular body 17 provides an aesthetical difference over the straight singular body 16 in order to appeal different consumer groups.

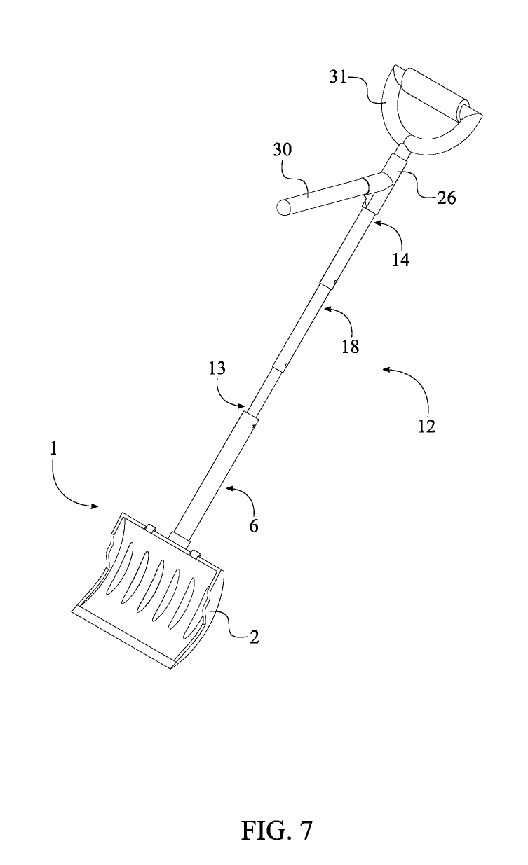

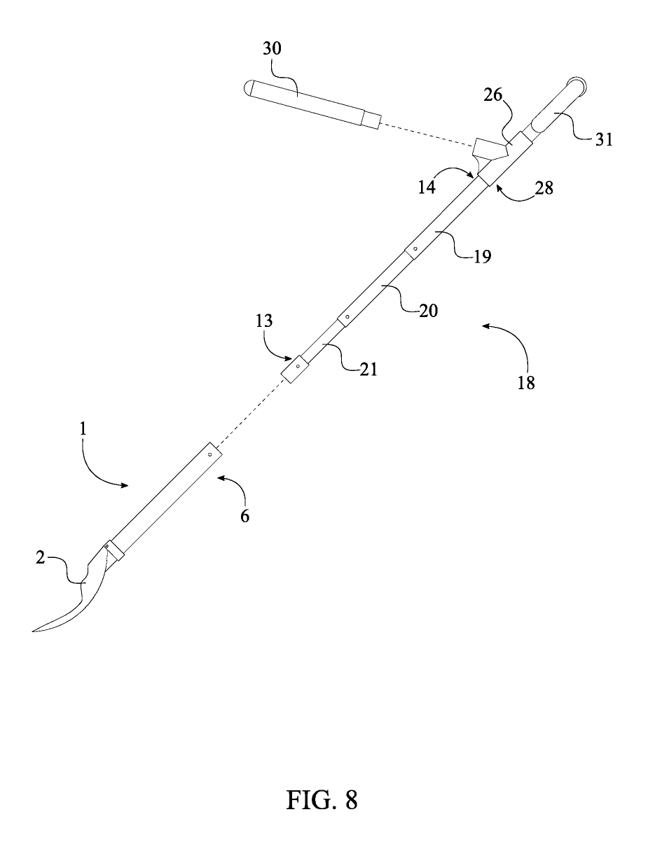

In reference to a third embodiment of the present invention, the primary support shaft 12 can be a straight telescopic body 18 as shown in FIG. 7-8. In other words, the straight telescopic body 18 allows the present invention to be configured into a retracted position during storage and shipping or configured into an extended position during usage. The straight telescopic body 18 also enables the user to control the overall height of the present invention. The straight telescopic body 18 comprises a proximal telescopic section 19, at least one intermediate telescopic section 20, and a distal telescopic section 21. More specifically, the proximal telescopic section 19 is concentrically connected to the second connector section 28. The at least one intermediate telescopic section 20 is slidably engaged with the proximal telescopic section 19, opposite of the second connector section 28. The distal telescopic section 21 is slidably engaged with the at least one intermediate telescopic section 20, opposite of the proximal telescopic section 19. As a result, the mounting body 6 is positioned adjacent to the distal telescopic section 21, opposite of the at least one intermediate telescopic section 20. For example, when the distance between the cleaning apparatus 1 and the handle 31 is minimized, the third embodiment is in the retracted position. When the distance between the cleaning apparatus 1 and the handle 31 is maximized, the third embodiment is in the extended position.

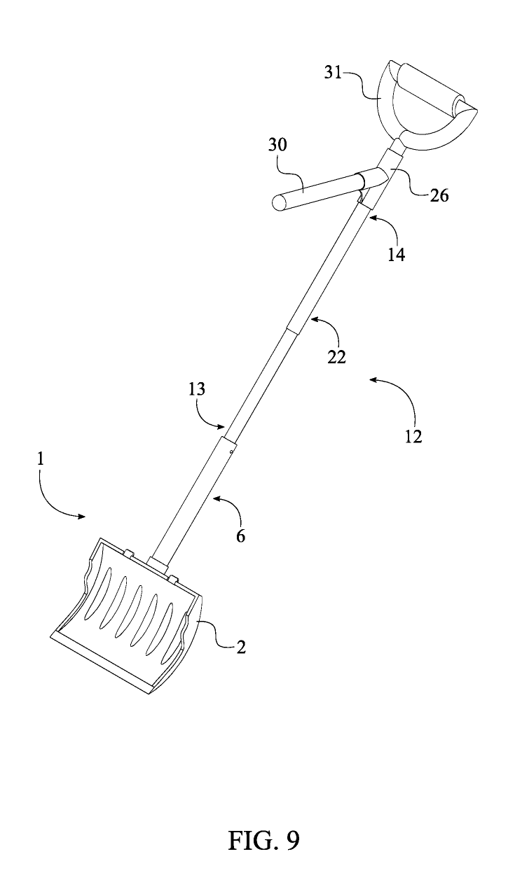

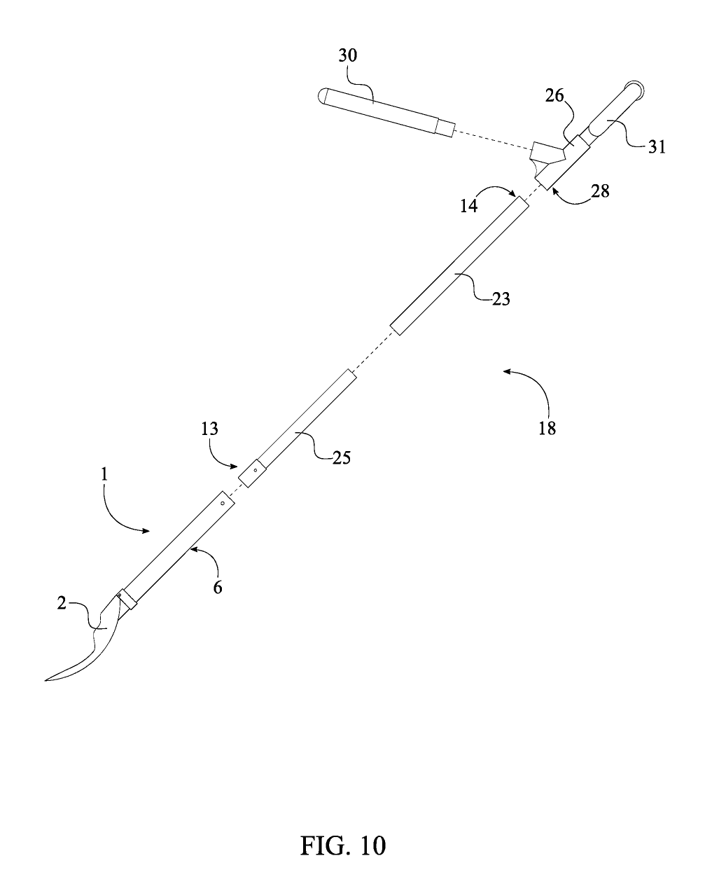

In reference to a fourth embodiment of the present invention, the primary support shaft 12 can be a straight modular body 22 as shown in FIG. 9-10. In other words, the straight modular body 22 allows the present invention to be disassembled for easy storage or shipping and provides the overall height adjustable options for the present invention during usage. The straight modular body 22 comprises a proximal modular section 23 and a distal modular section 25. More specifically, the proximal modular section 23 is concentrically positioned to the second connector section 28 and terminally attached to the second connector section 28. The distal modular section 25 is terminally attached to the proximal modular section 23, opposite of the second connector section 28. As a result, the mounting body 6 is positioned adjacent to the distal modular section 25, opposite of the proximal modular section 23. For example, when the fourth embodiment is shipped or stored, the proximal modular section 23 and the distal modular section 25 can be easily detached from the three-way connector 26 section and the cleaning apparatus 1 minimizing the overall volume of the present invention.

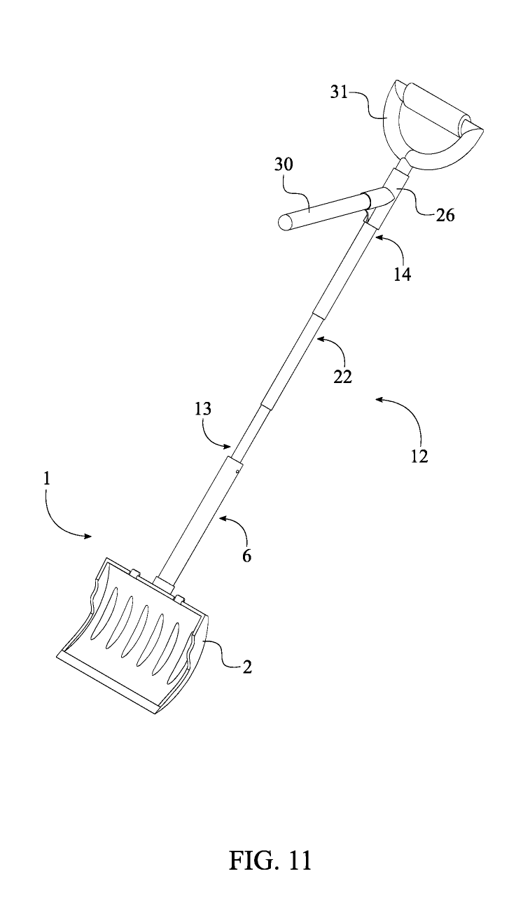

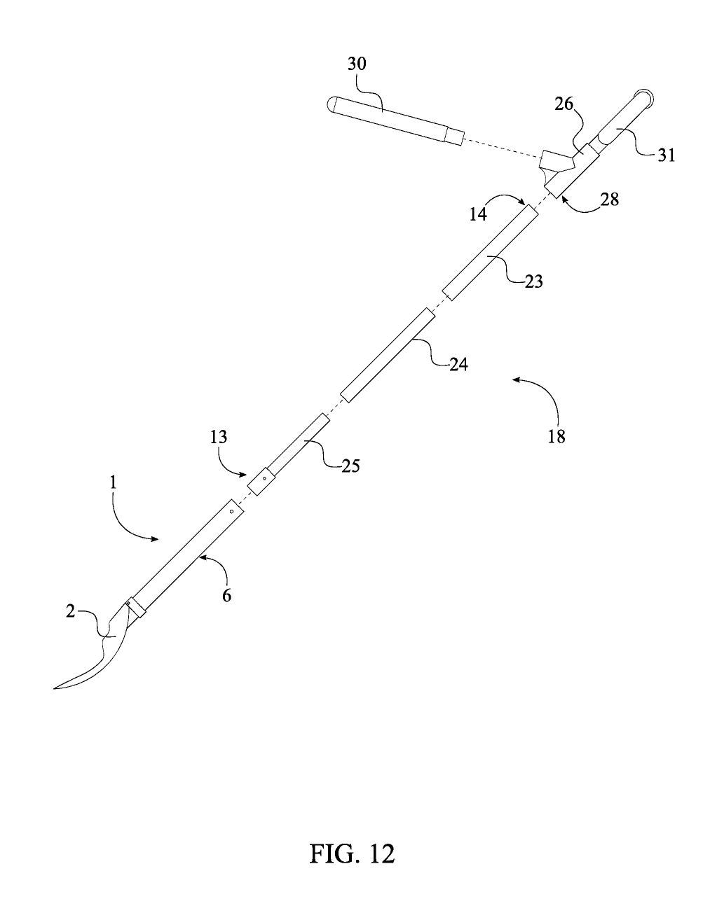

In reference to a fifth embodiment of the present invention, the primary support shaft 12 can be the straight modular body 22 as shown in FIG. 11-12 In other words, the straight modular body 22 allows the present invention to be disassembled for easy storage or shipping and provides the overall height adjustable options for the present invention during usage. The straight modular body 22 comprises the proximal modular section 23, at least one intermediate modular section 24, and the distal modular section 25. More specifically, the proximal modular section 23 is terminally attached to the second connector section 28. The at least one intermediate modular section 24 is terminally attached to the proximal modular section 23, opposite of the second connector section 28. The distal modular section 25 is terminally attached to the at least one intermediate modular section 24, opposite of the proximal modular section 23. As a result, the mounting body 6 is positioned adjacent to the distal modular section 25, opposite of the at least one intermediate modular section 24. For example, when the fifth embodiment is shipped or stored, the proximal modular section 23, the at least one intermediate modular section 24, and the distal modular section 25 can be easily detached from the three-way connector 26 section and the cleaning apparatus 1 minimizing the overall volume of the present invention.

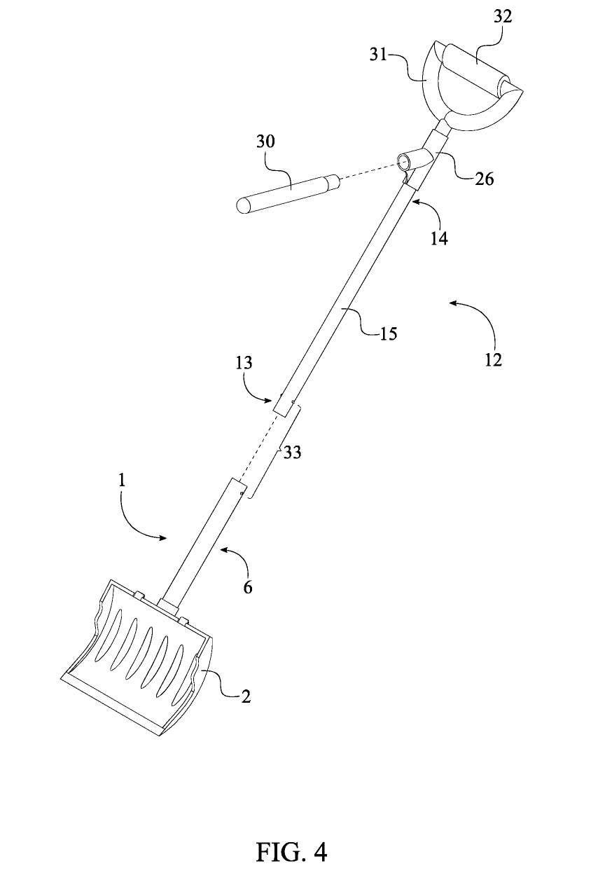

In reference to FIGS. 2 and 4, the first shaft end 13 is concentrically mounted within the mounting body 6 of the cleaning apparatus 1 so that the primary support shaft 12 and the cleaning apparatus 1 can be secured within the present invention. More specifically, an extension tube 11 of the mounting body 6 and the first shaft end 13 are mounted to each other by a fastener 33 so that the cleaning apparatus 1 can be detached when necessary. As a result, the first shaft end 13 can be interchanged with multiple cleaning apparatus 1 that are different in width, shape, or material to encompass different types of cleaning purposes. Additionally, when an old cleaning apparatus 1 is worn out and unusable, the worn-out cleaning apparatus 1 can be changed into a new cleaning apparatus 1 through the fastener 33. The present invention preferably utilizes a spring loaded button that is integrated into the first shaft end 13 and a corresponding opening that traverses through the extension tube 11 as the fastener 33. However, the fastener 33 is not limited to the preferred fastening mechanism and can include, but is not limited to, a screw fastener, a male and female threaded fastener, a clamp fastener, a snap fastener, and a latch fastener.

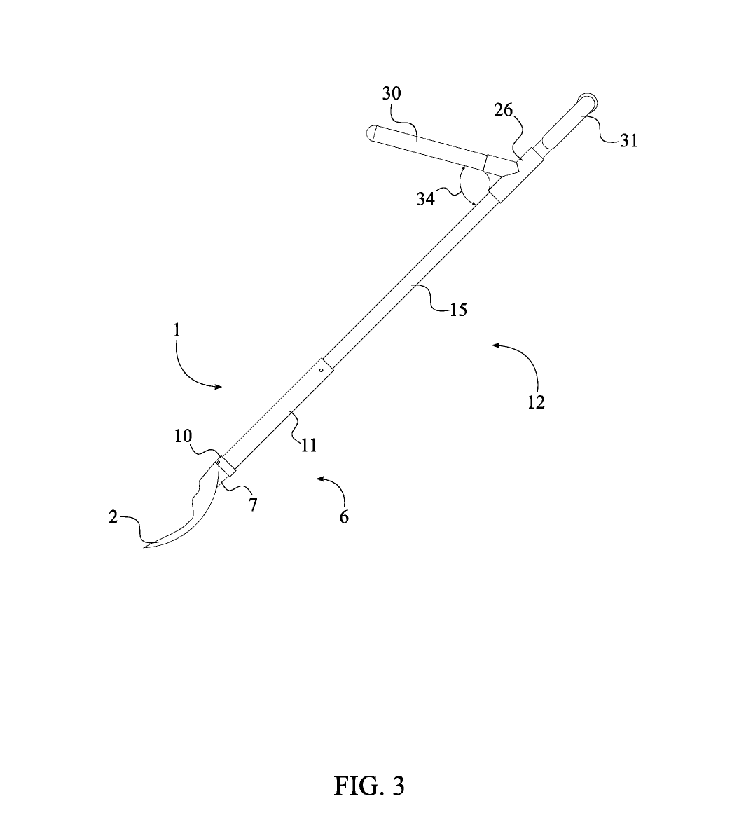

The cleaning apparatus 1 functions similar to existing mop head 2s so that dust can be collected and removed, liquid can be removed, or liquid can be spread, leaves can be collected, and dirt or snow can be moved within the present invention. In reference to FIG. 3, the cleaning apparatus 1 further comprises a head 2 in addition to the mounting body 6. The head 2 is utilized as the cleaning body that comes into the contact with the floor. The head 2 is adjacently attached to the mounting body 6 and positioned opposite of the first shaft end 13, about the mounting body 6. The mounting body 6 that secures the head 2 to the first shaft end 13 comprises a base 7, an adaptor 10, and the extension tube 11. More specifically, the base 7 is terminally connected to the adaptor 10. The extension tube 11 is terminally connected to the adaptor 10 and positioned opposite of the base 7. As a result, when the cleaning apparatus 1 is connected to the first shaft end 13, the extension tube 11 is positioned adjacent to the first shaft end 13 so that the first shaft end 13 can be terminally mounted to the extension tube 11 opposite of the adaptor 10. The head 2 is attached to the base 7 and positioned opposite of the extension tube 11 about the adaptor 10. The adaptor 10 functions as a supporting structure in between the base 7 and the extension tube 11 so that the structural integrity of the mounting body 6 can be improved. However, the mounting body 6 can also be configured without the adaptor 10 without departing from the spirit and scope of the invention. Furthermore, the basic configuration of the base 7 can differ to accommodate different embodiments of the present invention.

Depending upon different embodiment of the present invention, the head 2 can define the type of double-handle apparatus. For example, when the head 2 is defined as a shovel, rake, or hoe, the present invention is considered to be utilized within garden tools or household tools. When the head 2 is defined as a mop, squeegee, or broom, the present invention is considered to be utilized within cleaning tools or household tools.

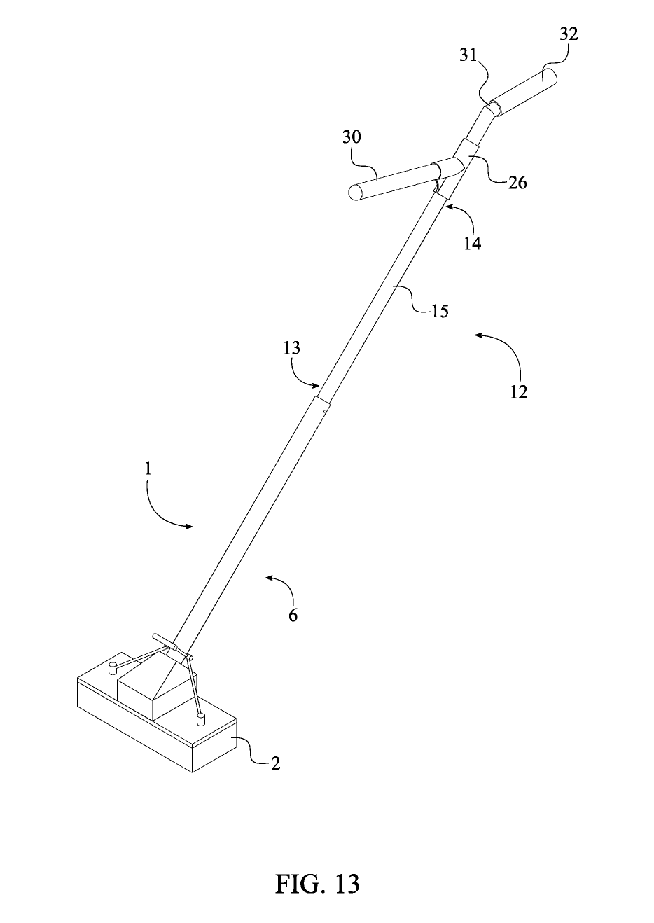

In reference to one embodiment, the head 2 is a sponge mop as shown in FIG. 13. The base 7 is a flat panel and is connected to the adaptor 10 so that the flat panel and the adaptor 10 share the same central axis. The head 2 is perimetrically connected around the flat panel as the sponge mop functions as an absorbent material so that liquid can be absorbed or spread around the floor. Additionally, a liquid draining mechanism that is operated by the user to drain liquid from the sponge mop can be configured onto the mounting body 6.

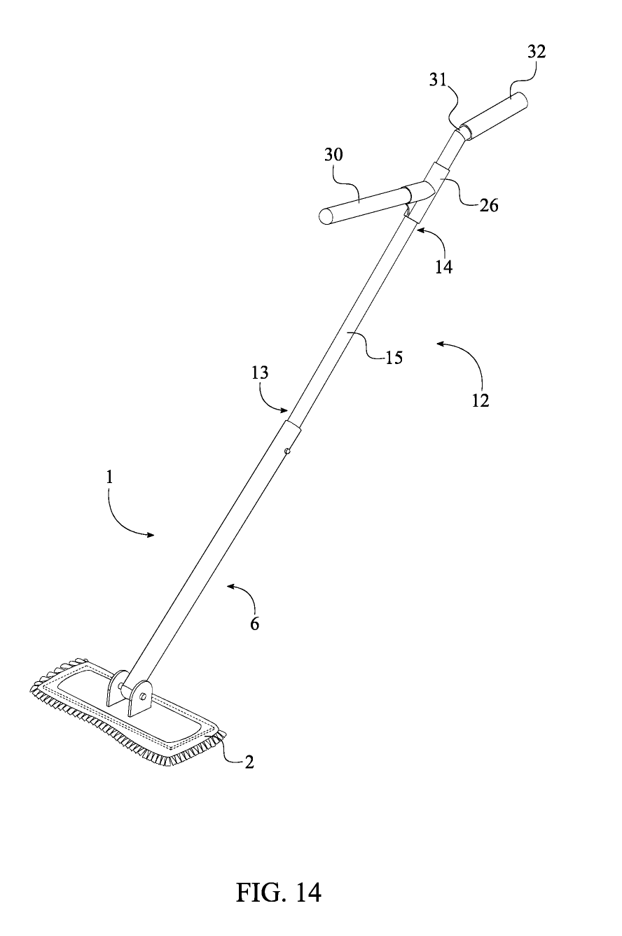

In reference to another embodiment, the head 2 is a dust mop as shown in FIG. 14. The base 7 is a flat panel and is pivotably connected to the adaptor 10 so that the flat panel is able to move 360 degrees around the adaptor 10. The head 2 is perimetrically attached around the flat panel as the dust mop comprises a layer of fabric and an elastic edge so that dust particles can be removed and compiled into a dust pile. More specifically, the layer of fabric is positioned adjacent to the flat panel and orients toward the floor so that the layer of fabric can retain the dust particles during the cleaning process. The elastic edge is tethered around the flat panel and positioned adjacent to the adaptor 10 so that the layer of fabric can be contained around the flat panel during the cleaning process. Furthermore, the elastic edge enables the easy attachment and removal of the dust mop within the present invention.

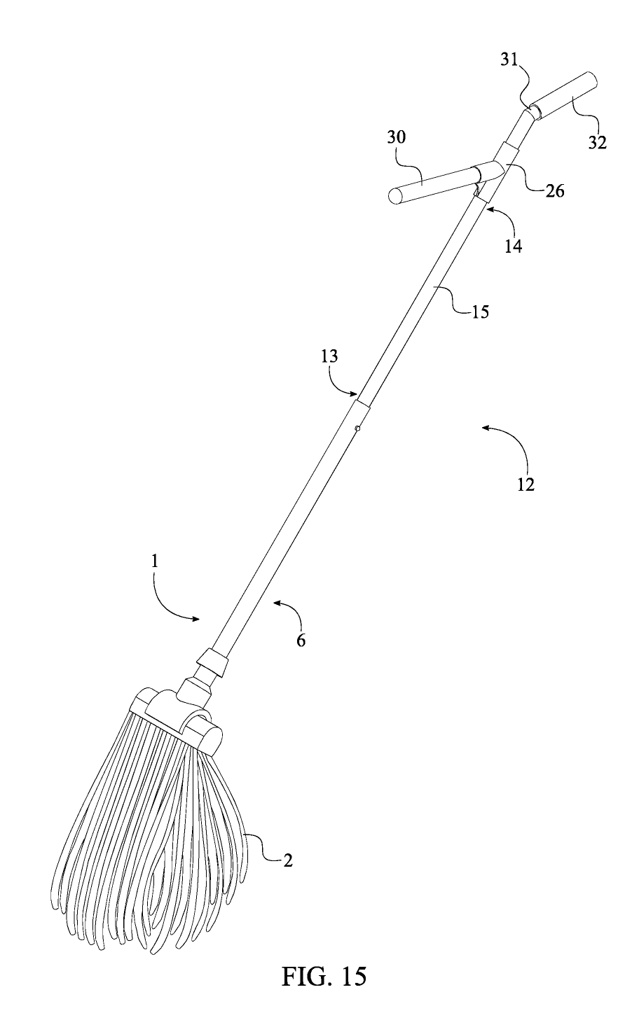

In reference to another embodiment, the head 2 is a wet mop as shown in FIG. 15. The base 7 is a clamp fastener and is axially connected to the adaptor 10. The head 2 is crimped into the clamp fastener. The wet mop functions similar to the sponge mop so that liquid can be absorbed or spread around the floor. Additionally, the wet mop can comprise a plurality of coarse strings or yarn that is connected to each other by an edge. The edge provides a strengthened surface area for the wet mop as the edge is generally crimped into the clamp fastener. Furthermore, the clamp fastener enables the easy attachment and removal of the wet mop within the present invention.

In reference to another embodiment, the head 2 is a shovel scoop. The base 7 is a collar and adjacently connected to the adaptor 10. The head 2 is connected to the collar so that snow or dirt can be collected, removed, or moved within the present invention.

In reference to another embodiment, the head 2 is a broom. The base 7 is a collar and adjacently connected to the adaptor 10. The head 2 is connected to the collar so that dirt can be moved from one location to another by the present invention.

In reference to another embodiment, the head 2 is a squeegee. The base 7 is a collar and adjacently connected to the adaptor 10. The head 2 is connected to the collar so that water or liquid can be moved from one location to another by the present invention.

In reference to another embodiment, the head 2 is a rake. The base 7 is a collar and adjacently connected to the adaptor 10. The head 2 is connected to the collar so that leaves, grass clippings, dirt, or other loss material can be moved from one location to another by the present invention.

In reference to another embodiment, the head 2 is a hoe. The base 7 is a collar and adjacently connected to the adaptor 10. The head 2 is connected to the collar so that dirt can be moved from one location to another by the present invention.

In reference to FIG. 1-2, the second shaft end 14 is adjacently positioned to the handle 31 so that shaft body 15 and the handle 31 can be secured through the three-way connector 26 section. Depending upon different embodiments, the shape of the handle 31 can differ to provide the optimal leverage. For example, when the head 2 of the present invention is a shovel, the handle 31 can be formed into a D-shaped handle. When the head 2 of the present invention is a mop, the handle 31 can be formed into an elongated body. The present invention further comprises a gripping body 32 as the gripping body 32 is externally connected around the handle 31. More specifically, the gripping body 32 provides ergonomic surface area to grasp the handle 31 so that the friction between the handle 31 and the user's hand can be enhanced. Furthermore, the overall shape of the gripping body 32 is determined upon the shape of the handle 31 due to the fact that the gripping body 32 fully encloses the handle 31.

The present invention may further comprise a grip to enhance the friction between the user's hand and the secondary support shaft 30. The grip is a generally flexible, preferably rubber or foam extrusion that wraps around the secondary support shaft 30.

The present invention further comprises a brace that is positioned in between the second connector section 28 and the third connector section 29. The brace improves the structural integrity between the primary support shaft 12 and the secondary support shaft 30 to improve the reliability of the present invention.

In reference to FIG. 3, the primary support shaft 12 and the secondary support shaft 30 delineate an acute angle 34 about the three-way connector 26. Preferably, the acute angle 34 can be measured in degrees within the present invention. Additionally, a length of the primary support shaft 12 is preferably larger to a length of the secondary support shaft 30. Collectively, the acute angle 34 and the larger length between the primary support shaft 12 and the secondary support shaft 30 position a top end of the secondary support shaft 30 in line with the handle 31 when the cleaning apparatus 1 is positioned flat against a floor. As a result, the user can comfortably grasp the handle 31 and the secondary support shaft 30 during the usage of the present invention without having to bend down. In other words, the user can grasp the handle 31 with one hand thus partially securing the present invention. The user can then fully secure the present invention by grasping the secondary support shaft 30 with the other hand. Since the top end of the secondary support shaft 30 is positioned in line with the handle 31, the user can simply extend their arm and grasp the secondary support shaft 30 without having to bend down.

Although the invention has been explained in relation to its preferred embodiment, it is to be understood that many other possible modifications and variations can be made without departing from the spirit and scope of the invention as hereinafter claimed.

What is claimed is:

1. A double-handle apparatus comprises:
a cleaning apparatus;
a primary support shaft;
a secondary support shaft;
a handle;
the primary support shaft comprises a shaft body and a three-way connector section;
a first shaft end of the shaft body being concentrically mounted within a mounting body of the cleaning apparatus;
a second shaft end of the shaft body being concentrically integrated to a second connector section of the three-way connector;
the handle being adjacently connected to a first connector section of the three-way connector; and
the secondary support shaft being concentrically integrated to a third connector section of the three-way connector.

2. The double-handle apparatus as claimed in claim 1 comprises:
the cleaning apparatus further comprises a head;
the head being adjacently attached to the mounting body; and
the head being oppositely positioned to the first shaft end, about the mounting body.

3. The double-handle apparatus as claimed in claim 1 comprises:
the cleaning apparatus further comprises a head;
the mounting body comprises a base, an adaptor, and an extension tube;
the base being terminally connected to the adaptor;
the extension tube being terminally connected to the adaptor, opposite of the base;
the head being attached to the base; and
the first shaft end being terminally mounted to the extension tube, opposite of the adaptor.

4. The double-handle apparatus as claimed in claim 3 comprises:
a fastener; and
the extension tube and the first shaft end being mounted to each other by the fastener.

5. The double-handle apparatus as claimed in claim 1 comprises:
a gripping body; and
the gripping body being externally connected around the handle.

6. The double-handle apparatus as claimed in claim 1, wherein the shaft body is a straight singular body.

7. The double-handle apparatus as claimed in claim 1, wherein the shaft body is a curved singular body.

8. The double-handle apparatus as claimed in claim 1, wherein the shaft body is a straight telescopic body.

9. The double-handle apparatus as claimed in claim 8 comprises:
the straight telescopic body comprises a proximal telescopic section, at least one intermediate telescopic section, and a distal telescopic section;
the proximal telescopic section being concentrically connected to the second connector section;
the at least one intermediate telescopic section being slidably engaged with the proximal telescopic section, opposite of the second connector section;
the distal telescopic section being slidably engaged with the at least one intermediate telescopic section, opposite of the proximal telescopic section; and
the mounting body being positioned adjacent to the distal telescopic section, opposite of the at least one intermediate telescopic section.

10. The double-handle apparatus as claimed in claim 1, wherein the shaft body is a straight modular body.

11. The double-handle apparatus as claimed in claim 10 comprises:
the straight modular body comprises a proximal modular section and a distal modular section;
the proximal modular section and the distal modular section being concentrically positioned to the second connector section;
the proximal modular section being terminally attached to the second connector section;
the distal modular section being terminally attached to the proximal modular section, opposite of the second connector section; and
the mounting body being positioned adjacent to the distal modular section, opposite of the proximal modular section.

12. The double-handle apparatus as claimed in claim 10 comprises:
the straight modular body comprises a proximal modular section, at least one intermediate modular section, and a distal modular section;
the proximal modular section, the at least one intermediate modular section, and the distal modular section being concentrically positioned to the second connector section;
the proximal modular section being terminally attached to the second connector section;
the at least one intermediate modular section being terminally attached to the proximal modular section, opposite of the second connector section;
the distal modular section being terminally attached to the at least one intermediate modular section, opposite of the proximal modular section; and
the mounting body being positioned adjacent to the distal modular section, opposite of the at least one intermediate modular section.

13. The double-handle apparatus as claimed in claim 1, wherein primary support shaft and the secondary support shaft delineate an acute angle about the three-way connector.
